(19) United States
(12) Patent Application Publication
(10) Pub. No.: US 2025/0158489 A1
(43) Pub. Date: May 15, 2025

(54) Temperature-Regulating Apparatus and Method For Producing Same

(71) Applicants: Schunk Sintermetalltechnik GmbH, Heuchelheim (DE); Schunk Sintermetalltechnik GmbH, Thale (DE); Weiss Technik GmbH, Reiskirchen (DE)

(72) Inventors: Christian Haack, Marburg (DE); Ingolf Langer, Quedlinburg (DE); Frank Baumgaertner, Staufenberg (DE)

(21) Appl. No.: 18/287,519

(22) PCT Filed: Apr. 22, 2021
(86) PCT No.: PCT/EP2021/060582

§ 371 Date: Oct. 11, 2024

(51) Int. Cl. H02K 9/19; F25B 21/00; H02K 5/20

(52) U.S. Cl. CPC H02K 9/19; F25B 21/00; H02K 5/203; F25B 2321/0022

(57) ABSTRACT

A temperature control device and a method for producing a temperature control device, in which the temperature control device comprises a stator, a rotor mounted to rotate on a shaft, and a drive assembly for rotating the rotor. The temperature control device has a magnetic field source and a temperature controller. The temperature controller has channels with a magnetizable material through which a fluid can flow as a heat transfer medium. The temperature controller at least partially disposed in a magnetic field of the magnetic field source and able to rotate relative thereto such that the magnetic field varies at each of the channels. The temperature controller is selected from at least a first temperature controller made of at least a first material having a first Curie temperature and a second temperature controller made of a second material having a second Curie temperature, which differs from the first Curie temperature.

This patent application is a national stage application of International Patent Application No. PCT/EP2021/060582 filed Apr. 22, 2021, the disclosure of which is incorporated herein by reference.

This disclosure relates to a temperature control device, in particular a magnetocaloric cooling device, and to a modular system and a method for producing a temperature control device, the temperature control device comprising a stator, a rotor mounted to rotate on a shaft, and a drive assembly for rotating the rotor, the temperature control device comprising a magnetic field source and a temperature controller, the temperature controller having channels with a magnetizable material through which a fluid flows as a heat transfer medium, the temperature controller being at least partially disposed in a magnetic field of the magnetic field source and being able to rotate relative thereto in such a manner that the magnetic field varies in each of the channels, an increasing magnetic flux of the magnetic field increasing a temperature of the magnetizable material and a decreasing magnetic flux of the magnetic field decreasing a temperature of the material.

Temperature control devices of this kind are based on what is referred to as the magnetocaloric effect, where magnetic materials heat up when they are moved into a magnetic field and cool down when they are removed from it. This change in temperature is based on a change in the entropy of the material caused by the magnetization. This effect can be used for heating or cooling, for example when the heated material is connected to a heat sink, allowing heat to be dissipated. After removal of the magnetic field, the material will cool down further. Compared to conventional cooling devices, temperature control devices of this kind have a significantly improved efficiency and are climate-friendly since no climate-damaging refrigerant has to be used.

Since the magnetizable calorimetric material must always be moved relative to the magnetic field or the magnetic field source, a distinction can be made between two types of temperature control devices. For instance, temperature control devices in which the material and the magnetic field source are moved linearly relative to each other and temperature control devices in which this movement is carried out rotationally are known. These temperature control devices then have a rotor, which can rotate on a shaft, and a stator.

The calorimetric material commonly consists of a mixture of materials and has a defined Curie point or Curie temperature, which is adapted to an operating temperature of the temperature control device in order to achieve maximum efficiency. An operating temperature of the material can vary in a temperature range of 2 K to 4 K. Larger temperature spreads can be achieved by connecting different materials or alloys or temperature control devices in series. Due to the comparatively narrow temperature range, such temperature devices are always individually adapted to an intended application. In addition to the calorimetric materials, an individual adaptation of the magnetic field source, which may be formed by permanent magnets, for example, and of the heat transfer medium is required in this case. The heat transfer medium can be a liquid, such as water, ethanol or glycerol. The disadvantage of the known temperature control devices is that they are comparatively expensive to manufacture due to their complex adaptation to special applications.

Therefore, the object of the present disclosure is to propose a temperature control device and a modular system and a method for producing a temperature control device which enable cost-effective manufacture.

This object is attained by a temperature control device as disclosed herein, a modular system as disclosed herein, a method as disclosed herein, and a use as disclosed herein.

The temperature control device, in particular a magnetocaloric cooling device, comprises a stator, a rotor mounted to rotate on a shaft, and a drive assembly for rotating the rotor, the temperature control device having a magnetic field source and a temperature controller, the temperature controller having channels with a magnetizable material through which a fluid can flow as a heat transfer medium, the temperature controller being at least partially disposed in a magnetic field of the magnetic field source and being able to rotate relative thereto in such a manner that the magnetic field varies at each of the channels, an increasing magnetic flux of the magnetic field increasing a temperature of the magnetizable material and a decreasing magnetic flux of the magnetic field decreasing a temperature of the material, wherein the temperature controller is selected from at least a first temperature controller made of at least a first material having a first Curie temperature and a second temperature controller made of a second material having a second Curie temperature, which differs from the first Curie temperature.

The magnetocaloric temperature controller can thus be selected from a plurality of temperature controllers which are themselves distinguished by their different magnetizable calorimetric materials. These temperature controllers each have a material with a Curie temperature which a material of the respective other temperature controller does not have. The respective temperature controllers can therefore be used for different temperature ranges. Since all the temperature controllers available for selection can be used with the stator, the rotor, the shaft, the drive assembly and the magnetic field source, it becomes possible to manufacture the temperature control device in large quantities at low cost. Only an individual adaptation of the temperature control device to an application is made by selecting the appropriate temperature controller, with all other components of the temperature control device remaining essentially unchanged. By producing, for example, a magnetic field source in larger quantities, it becomes possible to manufacture it more cost-effectively, thus reducing the manufacturing costs of a single temperature control device overall.

Consequently, the temperature control device can be configured in such a manner that the first temperature controller is interchangeable with the second temperature controller and vice versa. Furthermore, the modular design of the temperature control device makes it possible to modify the temperature control device as needed and to adapt it to a change of use, for example to a changed temperature range, by exchanging the temperature controller for a temperature controller having a different Curie temperature. It is then no longer necessary to completely replace the entire temperature control device. The temperature controller can therefore be configured and installed in the temperature control device in such a manner that the temperature controller can be installed and removed without great effort.

The channels can run in the axial direction of the shaft and each form an entry opening for the fluid at one axial end of the temperature controller and an exit opening for the fluid at an opposite axial end. The channels can be disposed parallel to the shaft or alternatively meander in the axial direction, for example. A cross section of the channels can be selected in such a manner that as large an amount of heat as possible can be transferred from an inner surface of the channels to the fluid. In particular, a geometric design of the channels can also be adapted to a difference in temperature achievable with the material and a flow rate of the fluid. In this manner, it can be ensured that the fluid experiences the difference in temperature achievable with the calorimetric material when passing through the respective channel.

A distributor can be disposed on at least one axial end, the distributor being configured to control the flow of the fluid through the channels. The term distributor can refer to any distributor which is suitable to stop and release or redirect the flow of the fluid through the channels. A magnetocaloric effect of the surrounding material is maximized in the process. The distributor can also be formed by a number of valves. The valves can be stationary with the distributor and can be switchable on their own, for example by rotation of the shaft or as solenoid valves.

Thus, a flow of fluid through first channels can be interrupted and a flow of fluid through second channels can be released; the interruption can occur upon movement of the first channels into the magnetic field and/or upon movement out of the magnetic field. For example, the distributor may be a plate at the axial end, the plate having openings overlapping with entry openings of channels. Upon movement of the openings relative to the entry openings of the channels, the channels are opened or closed. When the first channels are moved into the magnetic field, the fluid can be heated by the heating material with the result that the fluid in the channels can then be heated and finally discharged. After dissipation of the thermal energy from the fluid into an environment, for example by means of a heat exchanger, the fluid can again be directed into channels that are moved out of the magnetic field with the result that the material of the channels then cools. The fluid can then be further cooled in the channels concerned and can subsequently be discharged from them. Conversely, the fluid can be introduced into the channels in the opposite direction and can be heated at the heat exchanger with the result that a higher final temperature can be achieved and the temperature control device can be used as a heat pump.

Also, a flow of fluid through the channels can be continuous while the channels move into the magnetic field and while they move out of the magnetic field. In this case, the distributor redirects the fluid from one channel to another channel or to a heat exchanger or vice versa. The flow of the fluid through the channels is not interrupted. In particular, a particularly high efficiency can be achieved in this manner. Thus, the distributor does not have any valves or the like in this case.

Furthermore, the distributor can connect adjacent channels with each other in such a manner that the channels and the distributor together at least partially form meanders along a circumference of the temperature controller. The channels running axially along the circumference of the temperature controller can then be connected to one another at their respective ends via the distributor in such a manner that a meandering course of the channels across the circumference results. Channels disposed directly next to each other or only every second, third, fourth, etc. following channel can be connected to each other. By connecting the second, third, fourth, etc. following channels, it becomes possible to omit channels and thus adapt a temperature capacity of the temperature controller or the temperature control device to a demand, even during operation.

The temperature control device may comprise a fluid circuit with a transporting means for circulating the fluid and a heat exchanger for dissipating thermal energy of the fluid, the drive assembly comprising at least one electric motor. The fluid circuit can be a closed fluid circuit, which can be filled with water, ethanol or glycerol as a heat transfer medium, for example. The heat transfer medium can also be a refrigerant that undergoes a phase change within the temperature control device. The transporting means can be a pump or a compressor suitable for transporting the fluid, for example. In this case, the heat exchanger serves to dissipate thermal energy and can also be used to supply thermal energy if the temperature control device is used as a heat pump. In this case, the heat exchanger is connected within the fluid circuit and the fluid flows through it. The drive assembly can comprise the electric motor, which is then also used to drive the rotor and can be connected to the shaft. The electric motor can also drive the pump via the shaft, in which case the pump can be coupled to the shaft. A rotational speed of the rotor may be controlled by a control device for controlling the electric motor.

The rotor may comprise the temperature controller and the stator may comprise the magnetic field source or vice versa. For example, the magnetic field source may be part of the rotor, in which case the temperature controller is formed on the stator. In another embodiment, the magnetic field source may be formed on the stator, in which case the temperature controller is formed by the rotor.

The temperature controller may be a bushing, and the magnetic field source may be disposed inside and/or outside the bushing coaxially relative to the bushing; the magnetic field source may be formed by at least one permanent magnet or electromagnet. For example, the magnetic field source may be composed of a number of permanent magnets in such a manner that field lines of the magnetic field pass through the temperature controller. The permanent magnets may all be of the same or identical construction. The permanent magnet may be a neodymium magnet. Alternatively, the magnetic field source may be formed by an electromagnet. For example, the magnetic field source may be disposed inside the bushing, and the bushing may be surrounded by an armature made of magnetizable material, such as iron. Alternatively, a magnetic field source may also be disposed outside the bushing or on the outside thereof. The armature or the magnetic field source can surround the bushing or be disposed on it in such a manner that, when the bushing and the magnetic field source move relative to each other, the bushing or the channels passing through the bushing are at least partially moved into and out of the magnetic field.

In the flow direction of the fluid along the channels, materials with different Curie temperatures can be disposed in a sequence. For example, a first material with a first Curie temperature and another material with another Curie temperature can be disposed along a channel and/or distributed across a circumference of the temperature controller. The respective Curie temperatures can be matched to one another in such a manner that the first material heats or cools the fluid in a first temperature range and the other material heats or cools the fluid in another temperature range, the other temperature range being at least adjacent to the first temperature range or partially overlapping with it. More than two materials, for example four, eight, twelve or more materials with adjacent temperature ranges can be provided. This makes it possible to substantially increase an achievable difference in temperature when the fluid flows through the respective channel from an entry opening to an exit opening of the channel.

Furthermore, the materials can be disposed along a circumference of the temperature controller with different Curie temperatures in a sequence. This is advantageous if the channels together and the distributor together at least partially form meanders along a circumference of the temperature controller. In this case, the channels of the temperature controllers can be formed in one piece and without gape or the like. This makes it possible to optimize a flow resistance of the channels and to increase a speed of the rotor. Overall, this results in improved efficiency of the temperature control device.

Advantageously, the bushing can therefore be composed of at least two rings, the material of each of which has a different Curie temperature. In this case, the temperature controller can consist of a number of rings disposed in a defined sequence and forming the channels. The respective temperature controllers are thus even more easily adaptable to an intended application. The different temperature controllers can then also differ in terms of the number of rings used, for example depending on whether a large or comparatively small difference in temperature is to be achieved between an entry opening and an exit opening of the channel.

Alternatively, the material can exhibit a gradient of a Curie temperature in the flow direction of the fluid along the channels. The channels of the temperature controllers can then be formed without gaps or the like. If the calorimetric material consists of a material mixture, the material mixture can be varied in the course of a channel in such a manner that a Curie temperature of the material is continuously changed in the course of the channel. Heating or cooling of the fluid then always takes place in an effect-optimized area of the material for the respective temperature of the fluid.

A Curie temperature at an entry opening and a Curie temperature at an exit opening for the fluid on the temperature controller can exhibit a difference in temperature of at least 4 K, preferably 10 K, particularly preferably 20 K. An intended final temperature between −10° C. and +80° C., preferably in a range of −9° C. to +5° C., can be achieved.

The material can be a material mixture of lanthanum, iron, silicon, cobalt and/or other components. Alternatively, the material mixture can be composed of manganese, iron and phosphorus. The material may consist of a mixture of powders of the aforementioned materials.

The material may be formed into temperature control elements disposed on the channels or forming the channels at least partially or completely. The channels can be made of a material with good thermal conductivity, such as aluminum, and the temperature control elements on the channels or between the channels can be disposed in direct contact with the channels. Alternatively, the channels themselves can be formed by the temperature control elements by forming a flow opening or the channel in a temperature control element. Furthermore, it is possible to arrange the temperature control elements within channels so that a particularly good heat transfer between the fluid and the temperature control element is possible.

The temperature control elements can be produced by additive manufacturing, in particular powder injection molding, metal powder extrusion or laser melting. Furthermore, it is possible to form the temperature control elements by an additive manufacturing process, depending on the materials used. This also makes it possible to manufacture temperature control elements with complex geometries.

The modular system for forming a temperature control device comprises the temperature control device having a stator, a rotor mounted to rotate on a shaft, and a drive assembly for rotating the rotor, the temperature control device having a magnetic field source, the modular system comprising a set of temperature controllers, the set of temperature controllers comprising at least a first temperature controller and a second temperature controller, the first temperature controller comprising a first magnetizable material having a first Curie temperature, and the second temperature controller comprising a second magnetizable material having a second Curie temperature, which differs from the first Curie temperature, wherein the temperature control device is selectively formed by the first temperature controller or the second temperature controller. Since the modular system comprises the first temperature controller and the second temperature controller, which differ in their Curie temperatures, it becomes possible to adapt the temperature control device to different applications, depending on the target temperature to be reached or the difference in temperature to be achieved. The modular system can also comprise a number of other temperature controllers, each of which has a different Curie temperature.

In the method for forming a temperature control device, in particular a magnetocaloric cooling device, the temperature control device comprises a stator, a rotor mounted to rotate on a shaft, and a drive assembly for rotating the rotor, the temperature control device comprising a magnetic field source and a temperature controller, the temperature controller comprising channels having a magnetizable material, a fluid flowing through the channels as a heat transfer medium, the temperature controller being at least partially disposed in a magnetic field of the magnetic field source and being rotated relative thereto in such a manner that the magnetic field varies at each of the channels, an increasing magnetic flux of the magnetic field increasing a temperature of the magnetizable material, and a decreasing magnetic flux of the magnetic field decreasing a temperature of the material, wherein the temperature controller is selected from at least a first temperature controller made of at least a first material having a first Curie temperature and a second temperature controller made of a second material having a second Curie temperature, which differs from the first Curie temperature. For the advantages of the method, reference is made to the description of advantages of the device. Further advantageous embodiments of the method result from the feature descriptions described herein.

In the use of a refrigerant as a heat transfer medium of a temperature control device, the refrigerant undergoes a phase change within the temperature control device. The phase change makes is possible to make use of a change of state of the refrigerant as in a compression refrigeration machine and thus to transport enthalpy. An efficiency of the temperature control device can thus be further increased. Further advantageous embodiments of the use result from the feature descriptions described herein.

Hereinafter, the invention is explained in more detail with reference to the accompanying drawings.

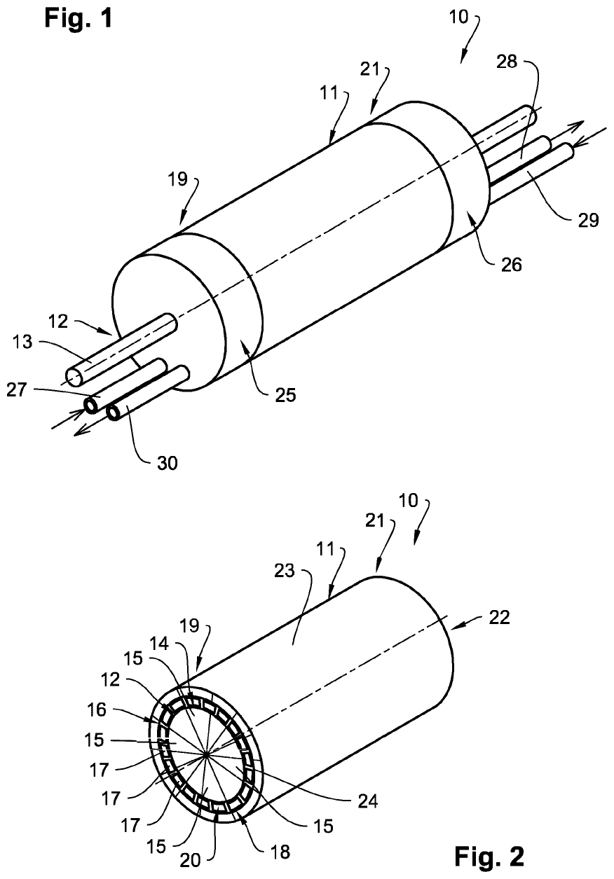

FIG. 1 is a schematic representation of a temperature control device in a perspective view;

FIG. 2 is a partial representation of the temperature control device of FIG. 1;

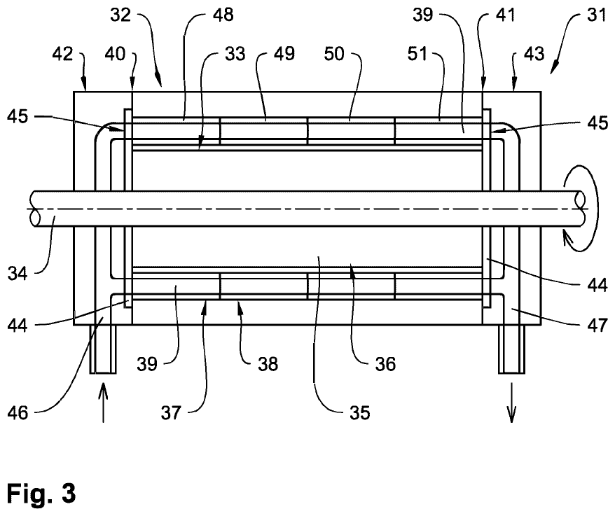

FIG. 3 is a longitudinal sectional view of a temperature control device.

FIG. 1 shows a schematic representation of a temperature control device 10, and FIG. 2 shows a partial representation of this temperature control device 10. The temperature control device 10 comprises a stator 11 and a rotor 12, which is mounted to rotate on a shaft 13. The rotor 12 has a magnetic field source 14 composed of permanent magnets 15. The stator 11 comprises a temperature controller 16, the temperature controller 16 having channels 17 through which a fluid can flow as a heat transfer medium. The temperature controller 16 is designed as a bushing 18, and the channels 17 run within the bushing 18 parallel to the shaft 13. The channels 17 each have an entry opening 20 at one axial end 19 of the bushing 18 and an exit opening 22 for the fluid at the opposite axial end 21. Furthermore, the temperature controller 16 has temperature control elements (not shown), which in principle can also form the temperature controller 16, in the area of the channels 17. The temperature control elements or the temperature controller 16 thus has a magnetizable material which can be moved in a magnetic field (not shown) of the magnetic field source 14 by a rotation of the rotor 12. The magnetic field can therefore be varied at the channels 17 by rotating the rotor 12 or the permanent magnets 15. The temperature controller 16 is further surrounded by a sleeve-shaped armature 23, which is made of a magnetizable material, such as iron. A gap 24 is formed between the rotor 12 and the stator 11.

At the respective axial ends 19 and 21, the temperature control device 10 has a distributor 25 and 26. Via the distributor 25 and 26, a flow of fluid through the channels 17 is controlled. When the channels 17 are moved into the magnetic field by a rotation of the permanent magnets 15 relative to the channels 17, the material of the temperature controller 16 is heated, the fluid then flowing through the respective channels 17. When the channels 17 are moved out of the magnetic field, the material of the temperature controller 16 and thus the fluid located in the channels 17 are cooled. A flow of the fluid through these channels 17 is interrupted by means of the distributor 25 or 26 and the fluid is transported out of the channels after having cooled.

A connection 27 for incoming, warm fluid is formed at the distributor 25, the fluid, which is then further heated in the temperature controller 16, being discharged again via a connection 28 and fed to a heat exchanger (not shown) of the temperature control device 10. In the heat exchanger, the fluid is cooled down again and fed back into the temperature controller 16 via a connection 29 on the distributor 26. After flowing through channels 17 and having cooled down therein, the fluid is discharged again from a connection 30 of the distributor 25. Since the fluid releases thermal energy at the heat exchanger, the fluid can be cooled after a complete passage of the temperature control device 10.

In particular, it is provided that the temperature control device 10 comprises the temperature controller 16, which is configured to be replaceable on the temperature control device 10. The temperature controller 16 has been selected from a set of temperature controllers (not shown), the set of temperature controllers having been selected from a first temperature controller comprising a first magnetizable material having a first Curie temperature and a second temperature controller comprising a second magnetizable material having a second Curie temperature, which is different from the first Curie temperature. This makes it possible to adapt the temperature control device 10 to different working temperatures and achievable differences in temperature between connections 27 and 30 without having to change the basic technical structure or a construction and shape of the temperature control device 10. In principle, it is possible to also use the temperature control device 10 as a heat pump if a flow direction of the fluid is reversed and the fluid is heated at the heat exchanger.

FIG. 3 shows a schematic sectional view of a temperature control device 31 with a stator 32, a rotor 33 and a shaft 34. A permanent magnet 35, which forms a magnetic field source 36, is disposed on the shaft 34 for co-rotation. The stator 32 comprises a temperature controller 37, which is a bushing 38 and coaxially surrounds the magnetic field source 36. Channels 39 through which a fluid (not shown) can flow as a heat transfer medium are formed inside the bushing 38. Distributors 42 and 43 via which a flow of the fluid through the channels 39 can be controlled are disposed at the axial ends 40 and 41 of the temperature control device 31, respectively. The distributors 42 and 43 each have a valve plate 44 with openings 45, valve plate 44 being moved with a rotation of the shaft 34 with the result that a supply channel 46 and a discharge channel 47 for the fluid are opened or closed with respect to the channels 39. The same applies to a return flow (not shown) of the fluid in the opposite direction via the channels 39.

The temperature controller 37 is composed of the number of temperature control elements 48 to 51. The temperature control elements 48 to 51 have an annular shape and consist of a magnetizable calorimetric material. Each of the temperature control elements 48 to 51 has a different Curie temperature. In particular, a Curie temperature of the temperature control elements 48 to 51 gradually increases in a flow direction of the fluid in such a manner that an efficiency of heating the temperature control elements 48 to 51 by the magnetic field source 36 is adapted to the temperature of the fluid prevailing at each of the temperature control elements 48 to 51 and thus optimized. Furthermore, the temperature controller 37 is selected from a set of temperature controllers (not shown), these temperature controllers differing by at least one temperature control element having a Curie temperature different from the other temperature control elements.

1. A temperature control device that is a magnetocaloric cooling device, the temperature control device comprising a stator, a rotor mounted to rotate on a shaft, and a drive assembly for rotating the rotor, the temperature control device having a magnetic field source and a temperature controller, the temperature controller having channels with a magnetizable material through which a fluid is flowable as a heat transfer medium, the temperature controller being at least partially disposed in a magnetic field of the magnetic field source and being able to rotate relative thereto in such a manner that the magnetic field varies at each of the channels, an increasing magnetic flux of the magnetic field increasing a temperature of the magnetizable material and a decreasing magnetic flux of the magnetic field decreasing a temperature of the material,
wherein
the temperature controller is selected from at least a first temperature controller made of at least a first material having a first Curie temperature and a second temperature controller made of a second material having a second Curie temperature, which differs from the first Curie temperature.

2. The temperature control device according to claim 1,
wherein
the temperature control device is configured in such a manner that the first temperature controller is interchangeable with the second temperature controller and vice versa.

3. The temperature control device according to claim 1,
wherein
the channels run in an axial direction of the shaft and each form an entry opening for the fluid at an axial end of the temperature controller and an exit opening for the fluid at an opposite axial end.

4. The temperature control device according to claim 3,
wherein
a distributor configured to control the flow of the fluid through the channels is disposed on at least one axial end.

5. The temperature control device according to claim 4,
wherein
a flow of fluid through first channels is interruptable and a flow of fluid through second channels is releasable, the interruption taking place when the first channels move into the magnetic field and/or out of the magnetic field.

6. The temperature control device according to claim 4,
wherein
a flow of fluid through the channels is able to be continuous when the channels move into the magnetic field and out of the magnetic field.

7. The temperature control device according to claim 6,
wherein
the distributor connects adjacent channels in such a manner that the channels and the distributor together at least partially form meanders along a circumference of the temperature controller.

8. The temperature control device according to claim 1,
wherein
the temperature control device comprises a fluid circuit with a transporting means for circulating the fluid and a heat exchanger for dissipating thermal energy of the fluid, the drive assembly comprising at least one electric motor.

9. The temperature control device according to claim 1,
wherein
the rotor comprises the temperature controller and the stator comprises the magnetic field source or vice versa.

10. The temperature control device according to claim 1,
wherein
the temperature controller is a bushing, and the magnetic field source is disposed inside and/or outside of the bushing coaxially relative to the bushing, the magnetic field source being formed by at least one permanent magnet or electromagnet.

11. The temperature control device according to claim 1,
wherein
materials having different Curie temperatures are disposed in a sequence in the flow direction of the fluid along the channels.

12. The temperature control device according to claim 11,
wherein
the materials are disposed along a circumference of the temperature controller with different Curie temperatures in a sequence.

13. The temperature control device according to claim 11,
wherein
the bushing is composed of at least two rings, whose respective materials have different Curie temperatures.

14. The temperature control device according to claim 1,
wherein
the material exhibits a gradient of a Curie temperature in the flow direction of the fluid along the channels.

15. The temperature control device according to claim 1,
wherein
a Curie temperature at an entry opening and a Curie temperature at an exit opening for the fluid on the temperature controller exhibit a difference in temperature of at least 4 K.

16. The temperature control device according to claim 1,
wherein
the material consists of a mixture of materials composed of lanthanum (La), iron (Fe), silicon (Si), cobalt (Co) and/or other components.

17. The temperature control device according to claim 1,
wherein
the material forms temperature control elements which are disposed on the channels or which at least partially or completely form the channels.

18. The temperature control device according to claim 17,
wherein
the temperature control elements are produced by additive manufacturing, powder injection molding, metal powder extrusion or laser melting.

19. A modular system for producing a temperature control device according to claim 1, the modular system comprising the temperature control device comprising a stator, a rotor mounted to rotate on a shaft, and a drive assembly for rotating the rotor, the temperature control device having a magnetic field source, the modular system comprising a set of temperature controllers, the set of temperature controllers comprising at least a first temperature controller and a second temperature controller, the first temperature controller comprising a first magnetizable material having a first Curie temperature and the second temperature controller comprising a second magnetizable material having a second Curie temperature, which differs from the first Curie temperature, the temperature control device being selectively provided with the first temperature controller or the second temperature controller.

20. A method for producing a temperature control device that is a magnetocaloric cooling device, the temperature control device comprising a stator, a rotor mounted to rotate on a shaft, and a drive assembly for rotating the rotor, the temperature control device having a magnetic field source and a temperature controller, the temperature controller having channels with a magnetizable material, a fluid flowing through the channels as a heat transfer medium, the temperature controller being at least partially disposed in a magnetic field of the magnetic field source and being rotated relative thereto in such a manner that the magnetic field varies at each of the channels, an increasing magnetic flux of the magnetic field increasing a temperature of the magnetizable material, and a decreasing magnetic flux of the magnetic field decreasing a temperature of the material,
wherein
the temperature controller is selected from at least a first temperature controller made of at least a first material having a first Curie temperature and a second temperature controller made of a second material having a second Curie temperature, which differs from the first Curie temperature.

21. A method of using a refrigerant as a heat transfer medium of a temperature control device according to claim 1, the method comprising changing a phase of the refrigerant within the temperature control device.
